(19) United States
(12) Patent Application Publication
(10) Pub. No.: US 2024/0395487 A1
(43) Pub. Date: Nov. 28, 2024

(54) ELECTROMAGNETIC RELAY

(71) Applicant: OMRON Corporation, Kyoto-shi, Kyoto (JP)

(72) Inventors: Shinichi OGAWA, Kyoto-shi, Kyoto (JP); Ryota MINOWA, Kyoto-shi, Kyoto (JP)

(21) Appl. No.: 18/696,363

(22) PCT Filed: Sep. 16, 2022
(86) PCT No.: PCT/JP2022/034675

§ 371 Date: Mar. 28, 2024

(30) Foreign Application Priority Data
Oct. 22, 2021 (JP) 2021-173388

(51) Int. Cl. H01H 50/04; H01H 50/36; H01H 50/54

(52) U.S. Cl. CPC H01H 50/045; H01H 50/36; H01H 50/54

(57) ABSTRACT

An electromagnetic relay includes a fixed terminal, a movable contact piece, a contact case, and a drive device. The fixed terminal includes a fixed contact. The movable contact piece includes a movable contact facing the fixed contact. The contact case is configured to accommodate the fixed contact and the movable contact piece. The drive device includes a fixed iron core to be screw-fastened to the contact case, and a yoke to be held between the fixed iron core and the contact case.

### CROSS-REFERENCE TO RELATED APPLICATION

This application is the U.S. National Phase of International Application No. PCT/JP2022/034675, filed on Sep. 16, 2022. That application claims priority to Japanese Patent Application No. 2021-173388, filed Oct. 22, 2021. The contents of those two applications are incorporated by reference herein in their entireties.

### FIELD

The claimed invention relates to an electromagnetic relay.

### BACKGROUND

Conventionally, an electromagnetic relay is known that includes a contact case in which a fixed contact and a movable contact piece are accommodated (see Japanese Patent Application Publication No. 2018-163761). The contact case is fixed to a yoke by means such as brazing or welding.

When the contact case is fixed by means such as brazing or welding, high component precision is required and the manufacturing costs increase.

### SUMMARY

An object of the claimed invention is to provide an electromagnetic relay in which a contact case can be fixed at low cost.

An electromagnetic relay according to one aspect of the claimed invention includes a fixed terminal, a movable contact piece, a contact case, and a drive device. The fixed terminal includes a fixed contact. The movable contact piece includes a movable contact opposing the fixed contact. The contact case configured to accommodate the fixed contact and the movable contact piece. The drive device includes a fixed iron core to be screw-fastened to the contact case, and a yoke to be held between the fixed iron core and the contact case.

In the electromagnetic relay, the contact case is fixed to the fixed iron core by screw-fastening, and thereby the contact case can be fixed at a lower cost than when the contact case is fixed by means such as brazing or welding. Since the contact case can be fixed in a simple manner, the production efficiency of the electromagnetic relays is improved. Furthermore, compared to the case where the contact case is fixed by means such as welding, high component precision is not required. The yoke is held between the fixed iron core and the contact case, and thereby the contact case can be fixed to the yoke in a simple manner.

The drive device may further include a bottomed cylinder in which the fixed iron core is partially accommodated. The bottomed cylinder may be held between the fixed iron core and the yoke. In this case, the bottomed cylinder can be fixed with a simple configuration.

The electromagnetic relay may further include an elastic member disposed between the yoke and the contact case. In this case, the elastic member can decrease the possibility of loosening of the screw-fastening and also reduce the operating noise of the electromagnetic relay.

The fixed iron core may include a large-diameter portion, a small-diameter portion smaller in diameter than the large-diameter portion, and a male screw portion on an outer peripheral surface of the small-diameter portion. The contact case may include a female screw portion to be screw-fastened to the male screw portion. In this case, the fixed iron core can be screw-fastened directly to the contact case.

The electromagnetic relay may further include a reinforcing member. The reinforcing member may be disposed between the male screw portion of the fixed iron core and the female screw portion of the contact case to reinforce the female screw portion of the contact case. In this case, the female screw portion can be strengthened.

The electromagnetic relay may further include a screw member to be screwed to the fixed iron core. The contact case may be screw-fastened to the fixed iron core via the screw member. The contact case may be held between the fixed iron core and the screw member. In this case, the contact case can be screw-fastened to the fixed iron core using, for example, a nut.

The contact case may be prevented from rotating by the yoke. In this case, when the contact case and the fixed iron core are screw-fastened, the yoke can be used to decrease displacement of the contact case.

The yoke may include a plurality of protrusions for preventing the contact case from rotating. In this case, the contact case can be prevented from rotating with a simple configuration.

The contact case may include a locking recess to be locked by the plurality of protrusions. In this case, the contact case can be prevented from rotating with a simple configuration.

The plurality of protrusions may penetrate the contact case. In this case, displacement of the contact case can be further decreased by the yoke.

The contact case may include a rotation-preventing portion that is be prevented from rotation by a side portion of the yoke. In this case, the contact case can be prevented from rotating with a simple configuration.

### BRIEF DESCRIPTION OF THE DRAWINGS

FIG. 1 is a schematic cross-sectional view of an electromagnetic relay in accordance with the claimed invention.

FIG. 2 is a schematic cross-sectional view of a fixed iron core and surrounding portions.

FIG. 3 is a perspective view of a contact case.

FIG. 4 is a schematic cross-sectional view of a fixed iron core and surrounding portions according to a modification.

FIG. 5 is a schematic cross-sectional view of a fixed iron core and surrounding portions according to a modification.

FIG. 6 is a schematic cross-sectional view of a fixed iron core and surrounding portions according to a modification.

FIG. 7 is a schematic cross-sectional view of a fixed iron core and surrounding portions according to a modification.

FIG. 8 is a schematic cross-sectional view of a fixed iron core and surrounding portions according to a modification.

FIG. 9 is a schematic cross-sectional view of a fixed iron core and surrounding portions according to a modification.

FIG. 10 is a schematic cross-sectional view of a fixed iron core and surrounding portions according to a modification.

### DETAILED DESCRIPTION

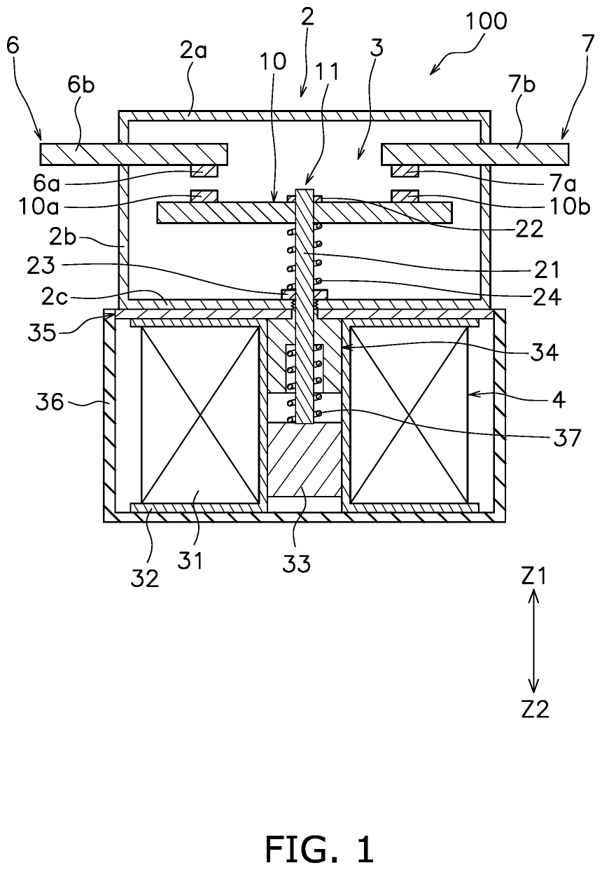

Hereinafter, one embodiment of an electromagnetic relay 100 according to one aspect of the claimed invention will be described with reference to the drawings. When referring to the drawings, for easier understanding of the description, the upper side in FIG. 1 will be referred to as “upper”, the lower side as “lower”, the left side as “left”, and the right side as “right”. In addition, a direction perpendicular to the paper plane of FIG. 1 will be described as a front-rear direction. These directions are defined for convenience of description, and do not limit the directions in which the electromagnetic relay 100 is arranged.

FIG. 1 is a schematic cross-sectional view of the electromagnetic relay 100. As shown in FIG. 1, the electromagnetic relay 100 includes a contact case 2, a contact device 3, and a drive device 4.

The contact case 2 has a substantially rectangular box shape and is comprised of insulating material such as resin. Note that the contact case 2 may be comprised of metal.

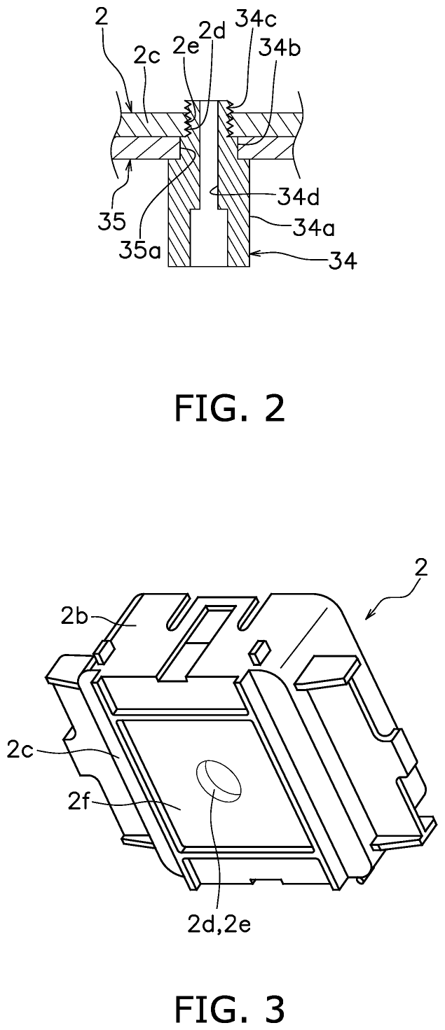

The contact case 2 includes a top surface portion 2a, side walls 2b, a bottom portion 2c, a through-hole 2d (see FIG. 2), and a female screw portion 2e (see FIG. 2). The top surface portion 2a has a rectangular shape when viewed from above. The side walls 2b extend downward from the front, rear, left, and right edges of the top surface portion 2a. The bottom portion 2c has a rectangular shape when viewed from above and faces the top surface portion 2a in the up-down direction. The bottom portion 2c is arranged below the top surface portion 2a and is connected to the side walls 2b. The through-hole 2d passes through the center of the bottom portion 2e in the up-down direction. The female screw portion 2e is formed on an inner surface of the through-hole 2d.

The contact device 3 includes a first fixed terminal 6, a second fixed terminal 7, a movable contact piece 10, and a movable mechanism 11.

The first fixed terminal 6 and the second fixed terminal 7 are plate terminals and extend in the left-right direction. The first fixed terminal 6 and the second fixed terminal 7 are spaced apart from each other in the left-right direction. The first fixed terminal 6 and the second fixed terminal 7 are comprised of conductive material such as copper.

The first fixed terminal 6 includes a first fixed contact 6a and a first external connection 6b. The first fixed contact 6a is accommodated in the contact case 2. The first fixed contact 6a is arranged on the lower surface of the first fixed terminal 6 within the contact case 2. The first fixed contact 6a may be integrated with the first fixed terminal 6. The first external connection 6b protrudes to the left from the side walls 2b of the contact case 2.

The second fixed terminal 7 includes a second fixed contact 7a and a second external connection 7b. The second fixed contact 7a is accommodated in the contact case 2. The second fixed contact 7a is arranged on the lower surface of the second fixed terminal 7 in the contact case 2. The second fixed contact 7a may be integral with the second fixed terminal 7. The second external connection 7b protrudes to the right from the side walls 2b of the contact case 2.

The movable contact piece 10 is a plate member that is long in one direction, and is comprised of conductive material such as copper. The movable contact piece 10 is accommodated in the contact case 2. The dimension of the movable contact piece 10 in the left-right direction is larger than the dimension of the movable contact piece 10 in the front-rear direction.

The movable contact piece 10 includes a first movable contact 10a and a second movable contact 10b. The first movable contact 10a is arranged at a position facing the first fixed contact 6a, and is configured to come into contact with the first fixed contact 6a. The second movable contact 10b is separated from the first movable contact 10a in the left-right direction. The second movable contact 10b is arranged at a position facing the second fixed contact 7a, and is configured to come into contact with the second fixed contact 7a. The first movable contact 10a and the second movable contact 10b may be integrated with the movable contact piece 10.

The movable contact piece 10 is configured to move in the direction in which the first movable contact 10a contacts the first fixed contact 6a (here, for example, upward) and in the direction in which the first movable contact 10a separates from the first fixed contact 6a (here, for example, downward).

The movable mechanism 11 includes a drive shaft 21, a first holding member 22, a second holding member 23, and a contact spring 24. The drive shaft 21 is coupled to the movable contact piece 10. The drive shaft 21 extends in the up-down direction and passes through the movable contact piece 10 in the up-down direction. The drive shaft 21 is arranged to move in the up-down direction.

The first holding member 22 is fixed to the drive shaft 21 above the movable contact piece 10. The second holding member 23 is fixed to the drive shaft 21 below the movable contact piece 10. The contact spring 24 is arranged between movable contact piece 10 and second holding member 23. The contact spring 24 urges the movable contact piece 10 upward via second holding member 23.

The drive device 4 is arranged below the contact device 3. The drive device 4 moves the movable contact piece 10 via the drive shaft 21 of the movable mechanism 11 by the electromagnetic force. The drive device 4 includes a coil 31, a spool 32, a movable iron core 33, a fixed iron core 34, a first yoke 35, a second yoke 36, and a return spring 37.

When excited by application of a voltage, the coil 31 generates an electromagnetic force which moves the movable iron core 33 upward. The spool 32 is cylindrical in shape, where the coil 31 is wound around the outer periphery. The movable iron core 33 is disposed inside the spool 32. The movable iron core 33 is connected to the drive shaft 21 so as to be integrally movable.

The fixed iron core 34 is arranged at a position facing the movable iron core 33. The fixed iron core 34 is disposed above movable iron core 33. The fixed iron core 34 is screw-fastened into contact case 2. The drive shaft 21 is disposed penetrating the fixed iron core 34 in the up-down direction. The drive shaft 21 is movable relative to the fixed iron core 34 in the up-down direction.

As shown in FIG. 2, the fixed iron core 34 includes a large-diameter portion 34a, a small-diameter portion 34b, a male screw portion 34c, and a through-hole 34d. The large-diameter portion 34a is disposed inside the spool 32. The large-diameter portion 34a is in contact with the first yoke 35 in the up-down direction. The small-diameter portion 34b protrudes upward from the upper portion of the large-diameter portion 34a. The small-diameter portion 34b has an outer diameter smaller than the outer diameter of the large-diameter portion 34a. That is, the dimension of the small-diameter portion 34b in the left-right direction is smaller than the dimension of the large-diameter portion 34a in the left-right direction. The small-diameter portion 34b is arranged to pass through the first yoke 35 and the through-hole 2d of the contact case 2 in the up-down direction.

The male screw portion 34c is formed on the tip outer peripheral surface of the small-diameter portion 34b. The male screw portion 34c is screwed to the female screw portion 2e of the contact case 2. With the configuration, the contact case 2 is fixed by screw-fastening to the fixed iron core 34. The through-hole 34d penetrates the centers of the large-diameter portion 34a and the small-diameter portion 34b in the up-down direction. The drive shaft 21 is disposed to pass through the through-hole 34d.

The first yoke 35 has a rectangular shape when viewed from above, and is arranged between the contact case 2 and the spool 32. The first yoke 35 covers the coil 31 from above. The upper surface of the first yoke 35 is in contact with the lower surface of the bottom portion 2c of the contact case 2. The first yoke 35 is held between the contact case 2 and the fixed iron core 34. Specifically, the first yoke 35 is held between the fixed iron core 34 and the contact case 2 in the up-down direction by the fastening force of screw-fastening between the contact case 2 and the fixed iron core 34.

The first yoke 35 has a through-hole 35a penetrating in the up-down direction. The through-hole 35a is arranged at a position overlapping the through-hole 2d of the contact case 2 in the up-down direction, and the small-diameter portion 34b of the fixed iron core 34 is positioned in the through-hole 35a. The through-hole 35a has an inner diameter smaller than the outer diameter of the large-diameter portion 34a of the fixed iron core 34. It is preferable that the gap between the through-hole 35a and the small-diameter portion 34b be small.

As shown in FIG. 1, the second yoke 36 has a U-shape when viewed from the front-rear directions. The second yoke 36 is arranged around the coil 31 and connected to the first yoke 35. The second yoke 36 covers the coil 31 from the left and right sides and from below.

The return spring 37 is arranged between the movable iron core 33 and the fixed iron core 34. The return spring 37 urges the movable iron core 33 downward.

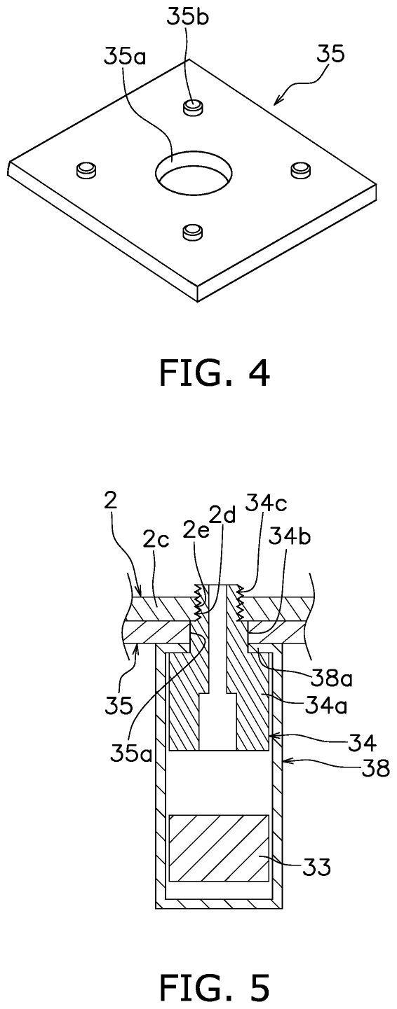

FIG. 3 is a perspective view of the contact case 2. FIG. 4 is a perspective view of the first yoke 35. The contact case 2 is prevented from rotating by the first yoke 35. The contact case 2 is restricted from rotating around the drive shaft 21 by the first yoke 35. Specifically, the contact case 2 includes a locking recess 2f. The locking recess 2f is located on the lower surface of the bottom portion 2c. The locking recess 2f is in a shape recessed from the bottom toward the top. The locking recess 2f has a rectangular shape when viewed from below.

The first yoke 35 includes several (i.e., a plurality of) protrusions 35b (four here for example). The protrusions 35b are located on the upper surface of the first yoke 35. The protrusions 35b respectively contact the side surfaces of the locking recess 2f within the locking recess 2f so as to prevent the contact case 2 from rotating.

The operation of the electromagnetic relay 100 is the same as the conventional one, and the description will be omitted.

In the electromagnetic relay 100 with the above configuration, the contact case 2 is fixed to the fixed iron core 34 by screw-fastening, and thereby the contact case 2 can be fixed at a lower cost as compared to the case where the contact case 2 is fixed by means such as brazing and welding. Since the contact case 2 can be fixed in a simple manner, the production efficiency of the electromagnetic relay 100 is improved. Furthermore, compared to the case where the contact case 2 is fixed by means such as welding, high component accuracy is not required. Since the first yoke 35 is held between the fixed iron core 34 and the contact case 2, the contact case 2 can be fixed to the first yoke 35 in a simple manner.

One embodiment of the electromagnetic relay according to one aspect of the claimed invention has been described above. The claimed invention, however, is not limited to the above embodiment, and various changes can be made without departing from the scope of the claimed invention.

The shapes of the first fixed terminal 6 and the second fixed terminal 7 may be changed. For example, the first fixed terminal 6 and the second fixed terminal 7 may be column-shaped terminals. An electromagnetic relay 100 may further include a case for covering the contact case 2 from the outside. In the contact case 2, the side walls 2b and the bottom portion 2c may be composed of a single member, and the top surface portion 2a may be a separate member from the bottom portion 2c and the side walls 2b. In this case, the case may also serve as the top surface portion 2a. In the contact case 2, the top surface portion 2a and the side walls 2b may be composed of a single member, and the bottom portion 2c may be a separate member from the top surface portion 2a and the side walls 2b.

The configuration of the drive device 4 may be changed. For example, the first yoke 35 and the second yoke 36 may be arranged upside down in the up-down direction. In this case, the second yoke 36 is held between the fixed iron core 34 and the contact case 2 when the contact case 2 is screw-fastened to the fixed iron core 34.

As shown in FIG. 5, the drive device 4 may further include a bottomed cylinder 38. The bottomed cylinder 38 is arranged inside the spool 32 and accommodates the movable iron core 33 and the large-diameter portion 34a of the fixed iron core 34. The bottomed cylinder 38 is held and fixed between the first yoke 35 and the fixed iron core 34 when the contact case 2 and the fixed iron core 34 are screw-fastened together. Specifically, the bottomed cylinder 38 includes a clamped portion 38a. The clamped portion 38a extends toward the small-diameter portion 34b of the fixed iron core 34 at the upper end of the bottomed cylinder 38. The clamped portion 38a is held between the first yoke 35 and the large-diameter portion 34a of the fixed iron core 34 in the up-down direction. Note that, in FIG. 5 and the subsequent drawings, illustrations of the drive shaft 21 and the return spring 37 are omitted.

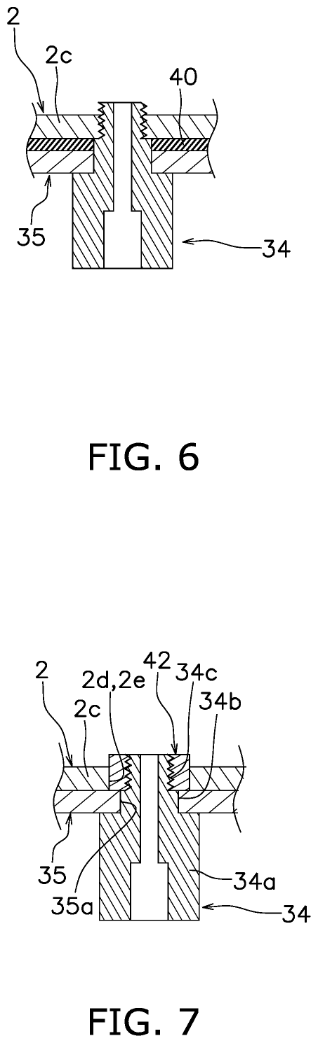

As shown in FIG. 6, the electromagnetic relay 100 may further include an elastic member 40. The elastic member 40 is arranged between the first yoke 35 and the bottom portion 2c of the contact case 2. The elastic member 40 is an elastically deformable cushioning material such as rubber.

As shown in FIG. 7, the electromagnetic relay 100 may further include a reinforcing member 42. The reinforcing member 42 is disposed between the male screw portion 34c of the fixed iron core 34 and the female screw portion 2e of the contact case 2, and reinforces the female screw portion 2e of the contact case 2. The reinforcing member 42 is, for example, a helical insert. Note that the female screw portion 2e of the contact case 2 may be formed by fitting a helical insert into the through-hole 2d.

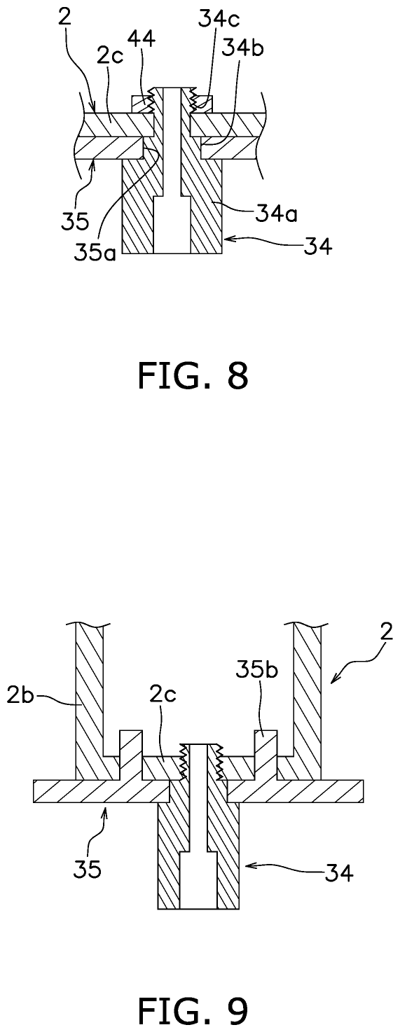

As shown in FIG. 8, the contact case 2 may be screw-fastened to the fixed iron core 34 via a screw member 44 configured to be threaded with the male screw portion 34c of the fixed iron core 34. The screw member 44 is, for example, a nut having a female screw. In this case, the contact case 2 is held between fixed iron core 34 and screw member 44. Note that the screw member 44 may be fitted into the bottom portion 2c of the contact case 2. For example, the screw member 44 having a female screw may be insert-molded in the contact case 2.

In the above embodiment, the contact case 2 is prevented from rotating by bringing the protrusions 35b into contact with the side surfaces of the locking recess 2f. However, the structure for preventing the contact case 2 from rotating is not limited to the said embodiment. For example, the contact case 2 may include a structure corresponding to the protrusions 35b, and the first yoke 35 may include a structure corresponding to the locking recess 2f.

As shown in FIG. 9, the protrusions 35b may penetrate the bottom portion 2c of the contact case 2 to prevent the contact case 2 from rotating. Note that the protrusions 35b do not necessarily need to penetrate the bottom portion 2c of the contact case 2. The protrusions 35b may have any shape as long as they engage with the bottom portion 2c of the contact case 2 to prevent the contact case 2 from rotating.

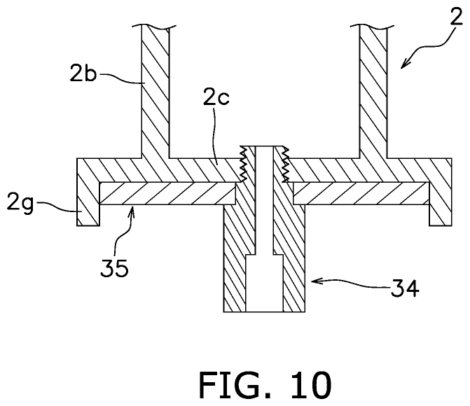

As shown in FIG. 10, the contact case 2 may include a rotation preventing portion 2g that is prevented from rotation by a side of the first yoke 35. The rotation preventing portion 2g is located on the outside of the side of the first yoke 35. In the example shown in FIG. 10, a pair of rotation preventing portions 2g are positioned on the left and right sides.

An adhesive may be applied between the male screw portion 34c of the fixed iron core 34 and the female screw portion 2e of the contact case 2. Similarly, an adhesive may be applied between the first yoke 35 and the fixed iron core 34.

In the above embodiment, the contact case 2 includes the female screw portion 2e, and the fixed iron core 34 includes the male screw portion 34c. However, the configurations of the female screw portion 2e and the male screw portion 34c may be interchanged. That is, the contact case 2 may have a male screw portion, and the fixed iron core 34 may have a female screw portion. In this case, for example, a cylindrical portion connected to the through-hole 2d of the contact case 2 may project downward from the bottom portion 2c of the contact case 2, and the male screw portion may be positioned on the outer peripheral surface of the cylindrical portion.

### REFERENCE NUMERALS

2: Contact case, 2e: Female screw portion, 2f: Locking recess, 2g: Rotation preventing portion, 4: Drive device, 6: First fixed terminal (Example of fixed terminal), 6a: First fixed contact (Example of fixed contact), 10: Movable contact piece, 10a: First movable contact (Example of a movable contact), 34: fixed iron core, 34a: Large-diameter portion, 34b: Small-diameter portion, 34c: Male screw portion, 35: First yoke (Example of yoke), 35b: A plurality of protrusions, 38: Bottomed cylinder, 40: Elastic member, 42: Reinforcing member, 100: Electromagnetic relay

1. An electromagnetic relay comprising:
a fixed terminal including a fixed contact;
a movable contact piece including a movable contact opposing the fixed contact;
a contact case configured to accommodate the fixed contact and the movable contact piece; and
a drive device including a fixed iron core to be screw-fastened to the contact case, and a yoke to be held between the fixed iron core and the contact case.

2. The electromagnetic relay according to claim 1, wherein
the drive device further includes a bottomed cylinder in which the fixed iron core is partially accommodated, and
the bottomed cylinder is held between the fixed iron core and the yoke.

3. The electromagnetic relay according to claim 1, further comprising:
an elastic member disposed between the yoke and the contact case.

4. The electromagnetic relay according to claim 1, wherein
the fixed iron core includes a large-diameter portion, a small-diameter portion smaller in diameter than the large-diameter portion, and a male screw portion on an outer peripheral surface of the small-diameter portion, and
the contact case includes a female screw portion to be screw to the male screw portion.

5. The electromagnetic relay according to claim 4, further comprising:
a reinforcing member disposed between the male screw portion of the fixed iron core and the female screw portion of the contact case to reinforce the female screw portion of the contact case.

6. The electromagnetic relay according to claim 1, further comprising:
a screw member to be screwed to the fixed iron core, wherein
the contact case is screw-fastened to the fixed iron core via the screw member, and
the contact case is held between the fixed iron core and the screw member.

7. The electromagnetic relay according to claim 1, wherein the contact case is prevented from rotating by the yoke.

8. The electromagnetic relay according to claim 7, wherein the yoke includes a plurality of protrusions configured to prevent the contact case from rotating.

9. The electromagnetic relay according to claim 8, wherein the contact case includes a locking recess to be locked by the plurality of protrusions.

10. The electromagnetic relay according to claim 8, wherein the plurality of protrusions penetrates the contact case.

11. The electromagnetic relay according to claim 7, wherein the contact case includes a rotation preventing portion that is prevented from rotating by a side portion of the yoke.
